(19) United States
(12) Patent Application Publication
(10) Pub. No.: US 2019/0176925 A1
(43) Pub. Date: Jun. 13, 2019

(54) BICYCLE ACCESSORY SYSTEM INCLUDING A BICYCLE AND AN ACCESSORY

(71) Applicant: Horrex Horren B.V., Alblasserdam (NL)

(72) Inventor: Eduardus Leonardus GENNISSEN, Alblasserdam (NL)

(21) Appl. No.: 16/310,154

(22) PCT Filed: Jun. 16, 2017
(86) PCT No.: PCT/NL2017/050399

§ 371 Date: Dec. 14, 2018

(30) Foreign Application Priority Data
Jun. 17, 2016 (NL) 2016993

(51) Int. Cl. B62K 19/40; B62K 19/02; B62J 7/06; B62J 11/00

(52) U.S. Cl. CPC B62K 19/40; B62K 19/02; B62K 11/02; B62J 11/00; B62K 2204/00; B62J 7/06

(57) ABSTRACT

Bicycle system including a bicycle and an accessory. The bicycle includes a frame including at least one beam, the at least one beam having a substantially constant cross section along its length. The accessory can be mounted to the frame by a clamp arranged to be clamped to the at least one beam. The at least one beam and the clamp are adapted to each other such that the clamp can be clamped to the at least one beam free from rotation around an axial direction of the at least one beam.

### FIELD OF THE INVENTION

The invention generally relates to bicycles. More in particular the invention relates to accessories for bicycles.

### BACKGROUND TO THE INVENTION

It is known to provide a bicycle with an accessory such as a basket, a light or a bottle holder. Such accessories are usually fixedly attached to the bicycle. Sometimes, e.g. in case of a basket the accessory is removably attached to the bicycle. Nevertheless, removing the accessory from the bicycle can be cumbersome.

### SUMMARY OF THE INVENTION

It is an object to provide a system which allows easy attaching and removing of an accessory. It is an object to provide a system which allows easy switching from one accessory to another. It is an object to provide a system which allows new accessories to be easily attached to the bicycle.

Although often a bicycle will be designed as a two-wheeled vehicle, the invention is not limited to two-wheeled vehicles. Herein the term bicycle also includes one-wheeled bicycles, such as unicycles, three-wheeled bicycles, such as trikes, and four-wheeled bicycles, such as quads. It will be appreciated that the bicycle may be provided with a motor, such as an electric motor. The bicycle then can be e.g. an electric bicycle. It is also possible that the bicycle is provided with an engine, such as a combustion engine. The bicycle can then e.g. be a scooter or a motorcycle. The motor and/or the engine can be arranged to provide propulsive power in addition to muscle power, or instead of muscle power.

Thereto according to an aspect is provided a bicycle system including a bicycle and an accessory. The bicycle includes a frame including at least one beam. The at least one beam has a substantially constant cross section along its length. The accessory is mounted to the frame by a clamp. The clamp is arranged to be clamped to the at least one beam. The at least one beam and the clamp are adapted to each other such that the clamp can be clamped to the at least one beam free from rotation around an axial direction of the at least one beam. Hence a clamp can be used for clamping the accessory to the beam without the accessory rotating out of position. The clamp may also prevent movement of the accessory in an axial direction of the beam, e.g. by means of friction.

Optionally, the at least one beam and/or the clamp has a cross section arranged for preventing rotation of the clamp around an axial direction of the at least one beam. Optionally, wherein the at least one beam has at least one groove and/or ridge along the length of an external surface. The groove and/or ridge allows for easy rotation prevention.

Optionally, the clamp has at least one ridge and/or groove complementary to the at least one groove and/or ridge of the at least one beam.

It will be appreciated that it is possible that the clamp is integral with the accessory. The accessory can then be clamped to the at least one beam.

Optionally, the bicycle system includes a carrier. The carrier can be positioned onto the clamp. The carrier and the clamp can be arranged to cooperate such that when the carrier is positioned onto the clamp, the carrier prevents unclamping of the clamp from the at least one beam. The carrier can e.g. at least partly surround the clamp so as to prevent unclamping of the clamp from the at least one beam. Optionally, the clamp and the carrier include cooperating means arranged to lock the carrier onto the clamp. Optionally, the carrier has an internal cavity having a shape complementary to an outer shape of the clamp. Hence, when positioned onto the clamp, the carrier can at least partly surround the clamp so as to prevent unclamping of the clamp from the at least one beam. Optionally, the carrier cavity is open to at least one side. Optionally, the carrier is arranged to be slid over the clamp so as to partly surround the clamp so as to prevent unclamping of the clamp from the at least one beam. Optionally, the carrier is arranged to be slid onto the clamp in a direction substantially parallel to the longitudinal direction of the at least one beam. Alternatively, or additionally the carrier is arranged to be slid onto the clamp in a direction substantially radial to the at least one beam. However, it is also possible that the carrier is arranged to be slid onto the clamp in a different direction.

Optionally, the clamp and/or the carrier can be arranged such that the clamp can be semi-permanently attached to the at least one beam. Thereto, the clamp and/or the carrier can include a semi-permanent fastener such as a screw, bolt, and/or c-ring.

Optionally, the accessory is attachable to the clamp and/or to the carrier. Hence, the accessory can easily be attached to the at least one beam of the bicycle. The beam having a substantially constant cross section along its length allows the accessory to be positioned at will. This enhance possibilities of personalizing the bicycle.

It will be appreciated that it is possible that the carrier is integral with the accessory. It is also possible that the carrier is integral with the clamp.

Optionally, the at least one beam includes at least one of a chain stay, a seat stay, a seat tube, a head tube, a top tube, a rear tube, a down tube, a fork, a stem riser, a handlebar, a seat post, a pedal, a stand, a luggage carrier, a hub, a rims. Hence, the accessory can be positioned at will.

Optionally at least two, preferably at least three, more preferably at least four, most preferably at least five of a chain stay, a seat stay, a seat tube, a head tube, a top tube, a rear tube, a down tube, a fork, a stem riser, a handlebar, a seat post, a pedal, a stand, a luggage carrier, a hub, and a rim, have an identical cross section for attaching the clamp as set out above. This provides the advantage that the accessory can be positions at many different positions on the bicycle.

Optionally, the accessory is at least one of a basket, a light, a bottle holder, a phone holder, a map holder, a fender, a tablet holder, a bag holder, an ornament, or the like. Optionally, the system including a plurality of mutually different accessories, each associated with its own clamp. Optionally the bicycle system includes a first accessory having a first clamp associated therewith, and a second accessory, different from the first accessory, having a second clamp associated therewith. The first and second clamps can be identical. Optionally, the bicycle system further includes a third accessory, different from the first and second accessories, having a third clamp associated therewith.

According to an aspect is provided a bicycle including a frame. The frame includes at least one beam arranged to receive a clamp such that the clamp is secured against rotation around an axial direction of the at least one beam. The at least one beam can have a substantially constant cross section along its length

Optionally, the bicycle is an electric bicycle.

According to an aspect is provided an accessory assembly including a clamp arranged to be clamped to at least one beam of a frame of a bicycle. The at least one beam can have a substantially constant cross section along its length. The clamp can be arranged to be clamped to the at least one beam free from rotation around an axial direction of the at least one beam

Optionally, the accessory assembly including a carrier, the carrier being positioned onto the clamp so as to prevent unclamping of the clamp from the at least one beam. The carrier and the clamp can be arranged to cooperate such that when the carrier is positioned onto the clamp, the carrier prevents unclamping of the clamp from the at least one beam. The carrier can e.g. at least partly surround the clamp so as to prevent unclamping of the clamp from the at least one beam.

Optionally, the accessory assembly includes an accessory attachable to the clamp and/or to the carrier.

According to an aspect is provided a clamp arranged to be clamped to at least one beam of a frame of a bicycle. The at least one beam can have a substantially constant cross section along its length. The clamp can be arranged to be clamped to the at least one beam free from rotation around an axial direction of the at least one beam.

Optionally, the clamp includes a carrier, the carrier being positioned onto the clamp and at least partly surrounding the clamp so as to prevent unclamping of the clamp from the at least one beam.

Optionally, the clamp and the carrier include cooperating means arranged to lock the carrier onto the clamp.

Optionally the clamp includes a connector for connecting an accessory thereto.

According to an aspect is provided a carrier arranged to be being positioned onto a clamp arranged to be clamped to at least one beam of a frame of a bicycle. The at least one beam can have a substantially constant cross section along its length. The clamp can be arranged to be clamped to the at least one beam free from rotation around an axial direction of the at least one beam. The carrier can be arranged to cooperate with the clamp so as to prevent unclamping of the clamp from the at least one beam.

Optionally, the carrier is arranged to at least partly surround the clamp so as to prevent unclamping of the clamp from the at least one beam.

Optionally, the carrier includes a connector for connecting an accessory thereto.

According to an aspect is provided an accessory arranged to be connected to a clamp and/or a carrier as described above.

According to an aspect is provided a method for providing an accessory assembly including an accessory and a clamp arranged to be clamped to at least one beam of a frame of a bicycle. The method includes receiving a design of an accessory or an accessory assembly. The method includes having an accessory or accessory assembly manufactured according to the design. The method can include providing the accessory or the accessory assembly, such as for use. The method can include providing the accessory or the accessory assembly for sale, rent, lease, or loan. The method can include providing the accessory or the accessory assembly via a webshop. The method can include receiving the design via a webportal.

According to an aspect is provided a method for providing an accessory of an accessory assembly including a clamp arranged to be clamped to at least one beam of a frame of a bicycle. The method includes receiving a design of the accessory. The method includes having the accessory manufactured according to the design. The method can include providing the accessory, such as for use. The method can include providing the accessory, such as for sale, rent, lease, or loan. The method can include providing the accessory via a webshop. The method can include receiving the design via a webportal.

It will be appreciated that any of the aspects, features and options described in view of the bicycle system apply equally to the bicycle, the accessory assembly, the clamp, the carrier, the accessory and the methods. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic representation of an example of a bicycle system;

FIG. 2 shows a number of examples of cross sectional views of beams;

FIGS. 3A-3D shows schematic cross sectional views of a combination of a beam and a clamp;

FIGS. 4A and 4B shows schematic views of a clamp and a beam;

FIGS. 5A-5E show schematic views of a clamp assembly;

FIGS. 6A and 6B show schematic views of a clamp assembly;

FIGS. 7A and 7B show schematic views of a clamp assembly;

FIGS. 8A and 8B show schematic views of a clamp assembly.

### DETAILED DESCRIPTION

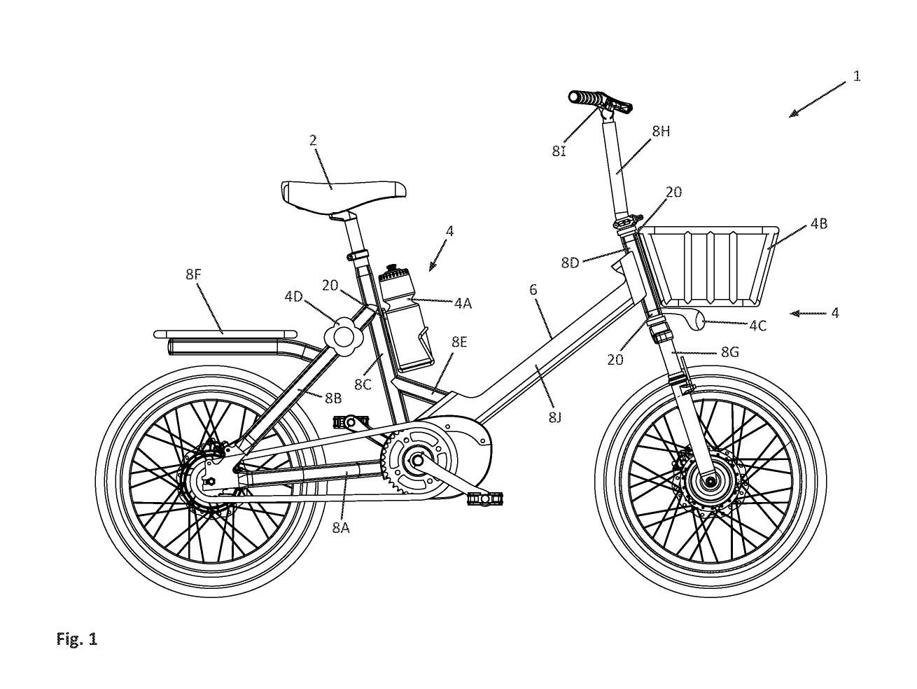

FIG. 1 shows an example of a bicycle system 1 according to the invention. In general, the bicycle system 1 includes a bicycle 2 and an accessory 4. In this example the bicycle system 1 includes a first accessory embodied as a bottle holder 4A. In this example the bicycle system 1 includes a second accessory embodied as a basket 4B. In this example the bicycle system 1 includes a third accessory embodied as a light 4C. In this example the bicycle system 1 includes a fourth accessory embodied as an ornament 4D. Connection of the accessories to the bicycle will be described in more detail below. In this example the bicycle 2 is an electric bicycle.

The bicycle 2 includes a frame 6. The frame 6 includes a plurality of beams 8. In this example the beams formed by chain stays 8A, seat stays 8B, seat tube 8C, head tube 8D, top tube 8E, and rear tube 8F all have the same substantially constant cross section along its length. It will be appreciated that in this example the top tube 8E does not extend to the head tube 8D and the down tube 8J acts as mono-tube. Here the down-tube 8J houses a battery 10 for the motor 12. It will be appreciated that other frame constructions are possible. It is for instance possible that the top tube 8E extends to the head tube 8C. It is also possible that the down tube 9 has the same cross section as the top tube 8E. It is also possible that the forks 8G have the same cross section as the top tube 8E. It is also possible that the stem riser 8H has the same cross section as the top tube 8E. It is also possible that the handlebars 81 have the same cross section as the top tube 8E. However, other parts of the bicycle may have the same cross section as well, such as the seat post, pedals, stand, luggage carrier, hubs, rims, etc.. Also a bicycle cart can include beams having the same cross section.

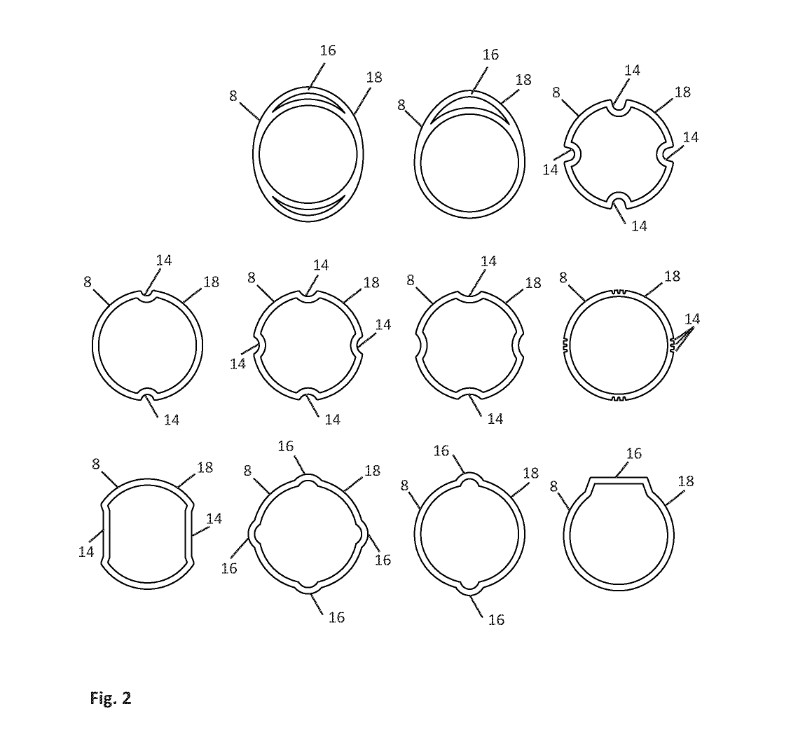

FIG. 2 shows examples of cross sectional views of the beams 8. Hence one or more of the beams 8A, 8B, 8C, 8D, 8E, 8F, 8G, 8H, 81, 8J can have such cross section. Here the beam has at least one groove 14 and/or ridge 16 along the length of an external surface 18. It will be appreciated that these beam cross sections allow for mounting a clamp to the beam such that rotation of the clamp around an axial direction of the beam can be prevented.

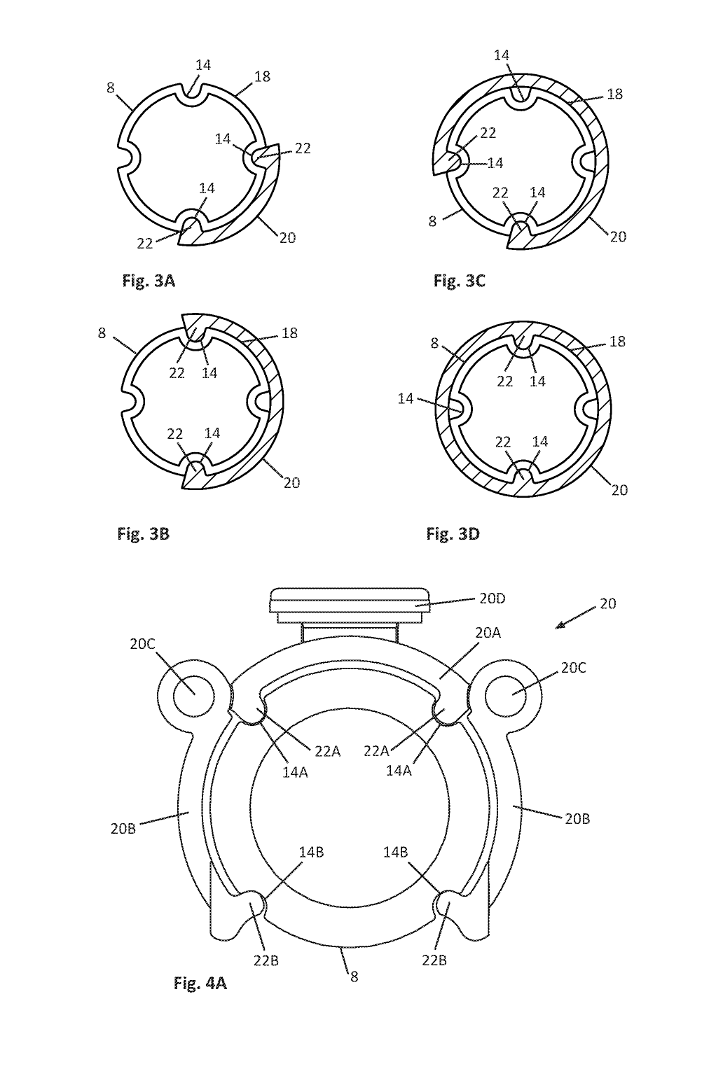

FIGS. 3A-3D show examples of a cross sectional view of a beam 8 and a corresponding clamp 20. In this example the beam has four longitudinal grooves 14. The grooves 14 are spaced equidistantly along the circumferential surface 18 of the beam 8. The clamp 20 clamp has two ridges 22. Here the ridges 22 are complementary to the grooves 14 of the beam 8. The ridges 22 cooperate with the grooves 14 so as to prevent rotation of the clamp 20 around the beam 8.

In FIG. 3A the clamp 20 includes a quarter segment and grips into two adjacent grooves 14 of the beam 8. In FIG. 3B the clamp 20 includes a half segment and grips into two opposite grooves 14 of the beam 8. In FIG. 3C the clamp 20 includes a three-quarter segment and grips into two adjacent grooves 14 of the beam 8. In FIG. 3D the clamp 20 includes a full circumference and, in this example grips into two opposite grooves 14 of the beam 8.

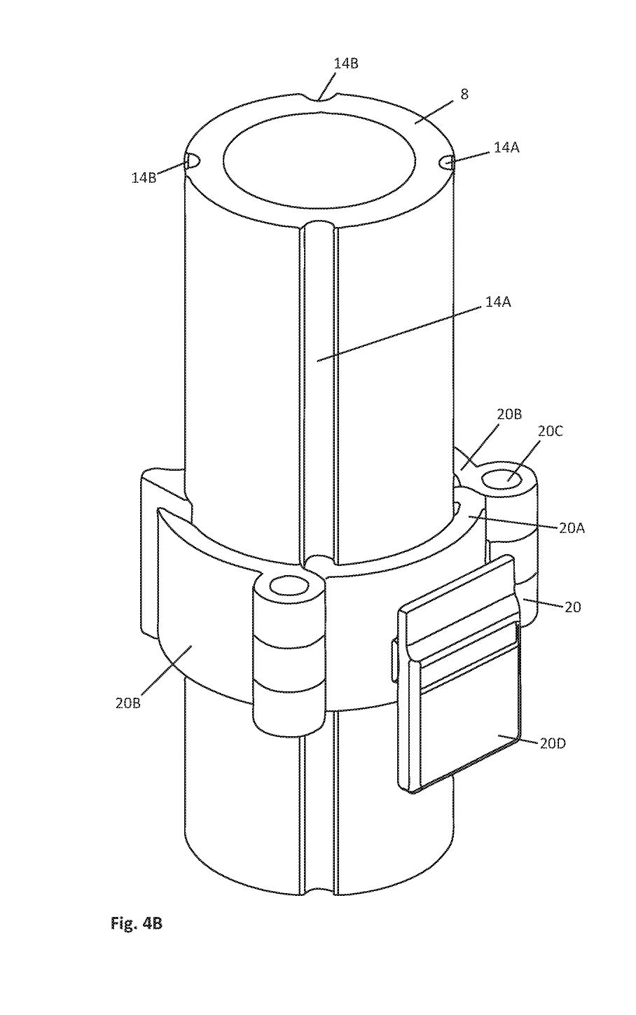

FIGS. 4A and 4B shows an example of a clamp 20. In this example the clamp includes a base 20A and two clips 20B. The clips 20B are hingedly connected to the base 20A. Here the clips 20B are connected to the base 20A via pivot axles 20C. In this example the base 20A includes two ridges 22A which insert into two grooves 14A of the beam 8. Each clip 20B includes a further ridge 22B. The clips can be hinges towards the beam so as to snap the further ridges 22B into the grooves 14B of the beam. Here the further ridges 22B are dimensioned so as to provide a biasing force onto the grooves 14B of the beam 8. Hence, the clamp 20 force fittingly attaches to the beam 8. It will be appreciated that it is also possible that the further ridges 22B are shaped so a as to hook behind a portion of the groove 14B. The clamp 20 includes an attachment 20D. The attachment is arranged for attaching further parts relating to an accessory 4 thereto.

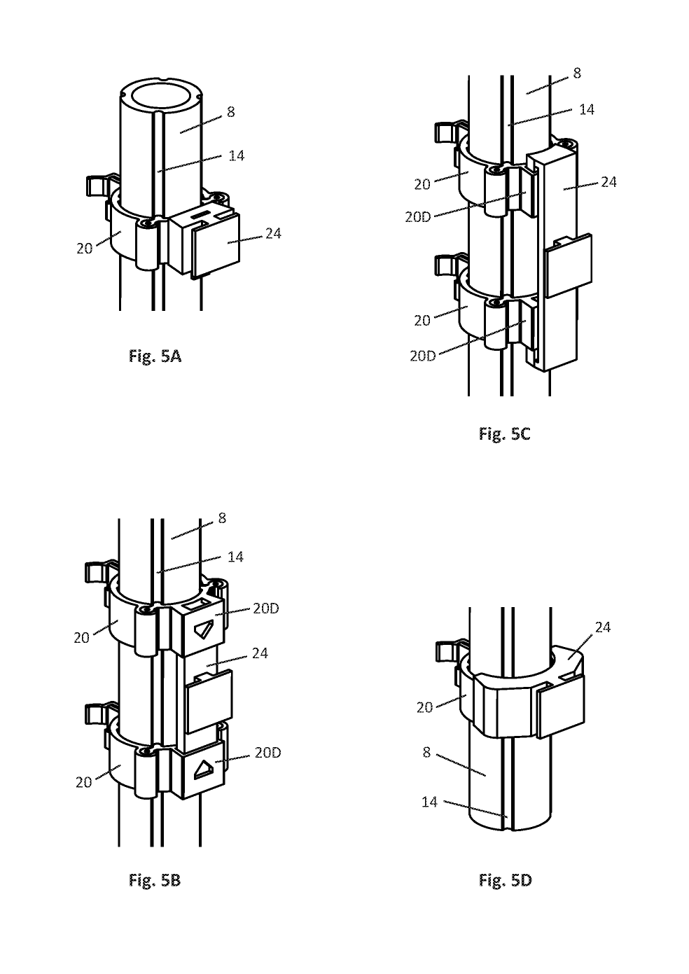

FIGS. 5A-5D show four examples of a carrier 24 being mounted to one or two clamps 20. In FIG. 5A the carrier 24 is mounted over the attachment 20D. In FIG. 5B each clamp 20 includes a box shaped attachment 20D. Open sides of the boxes face each other. The carrier 24 is inserted into the box shaped attachments. In FIG. 5C each clamp 20 includes a box shaped attachment 20D. Open sides of the boxes face away from other. The carrier 24 includes hooks 24A inserted into the box shaped attachments. In FIG. 5D the carrier is mounted over the attachment 20D. Here the carrier 24 includes sleeves 24B enclosing the hinge of the clamp 20 so as to prevent the clamp from detaching from the beam 8. The carrier 24 can have an internal cavity shaped complementary to an external shape of the clamp. Then, when the carrier 24 is mounted over the clamp 20 the clamp 20 is locked to the beam 8 and prevented from being released from the beam.

The carrier 24 includes a connector 26 for connecting an accessory thereto. FIG. 5E shows an example of a bottle holder 28 being connected to the connector 26.

It will be appreciated that the accessory 4 can be connected to the connector 26. It is also possible that the carrier 24 is integral with the accessory 4. The accessory 4 can then be connected to the attachment 20D. It is also possible that the carrier 24 is integral with the clamp 20. The clamp 20 then need not have an attachment 20D, but can have a connector 26. It is also possible that the clamp 20 is integral with the accessory 4. The accessory 4 can then be clamped to the beam 8. The accessory 4 and the clamp 20, and optionally the carrier 24, form an accessory assembly.

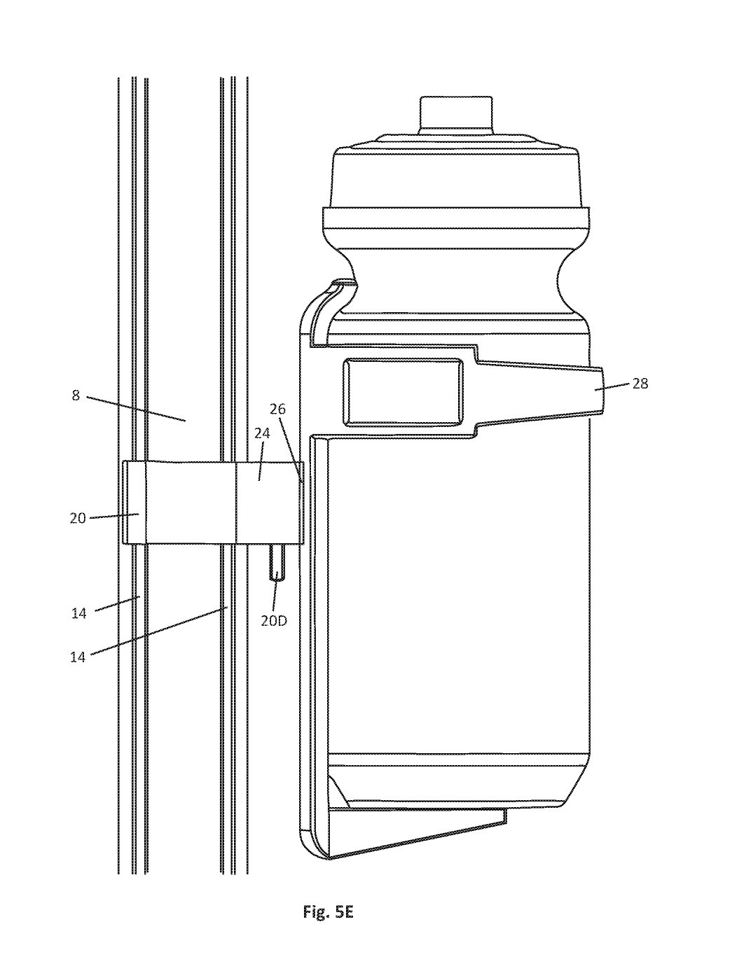

FIGS. 6A and 6B shows an example wherein the carrier 24 is attached to the clamp 20 by sliding. For clarity the connector 26 has been omitted from these Figures. In FIG. 6A part of the carrier 24 is broken away to show the internal functioning. The attachment 20D of the clamp is designed as a resilient lip. The carrier 24 includes a retainer 24A. The retainer 24A is here designed as a rod. The carrier can be slid onto the clamp 20 in a downward direction in FIGS. 6A and 6B. The retainer 24A hooks behind the resilient lip. Once the carrier 24 is in its final position, the lip grabs the retainer by a complementary structure, here a hollow to accommodate the rod. To release the carrier 24 from the clamp 20, the resilient lip can be pushed to release the rod. Then the carrier can be slid of the clap 20 in a upward direction in FIGS. 6A and 6B. It will be appreciated that it is also possible that the carrier includes a resilient lip and the clamp includes a retainer.

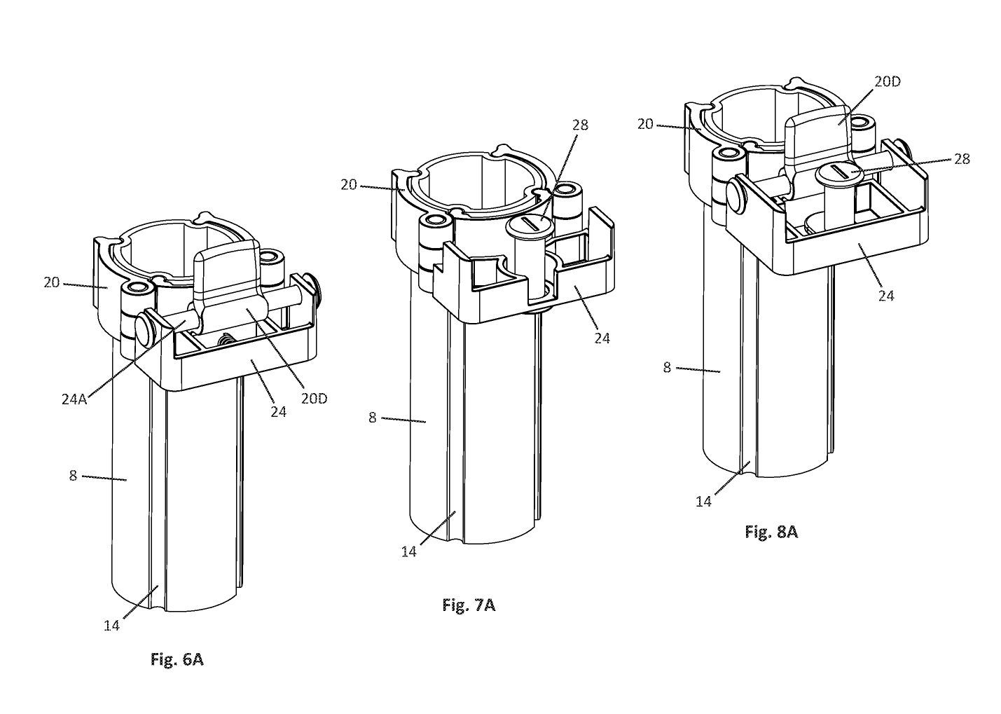

FIGS. 7A and 7B shows an example wherein the carrier 24 is attached to the clamp 20 by sliding. For clarity the connector 26 has been omitted from these Figures. In FIG. 7A part of the carrier 24 is broken away to show the internal functioning. In this example the carrier 24 includes a lock 28. The lock 28 can be a key operated lock. Alternatively the lock 28 can be a numerical lock. When the lock 28 is brought from the unlocked to the locked situation, a latch of the lock is brought from a releasing position into a locking position in which it engages the clamp 20. With the latch in the locking position the carrier is locked to the clamp and cannot be removed from the clamp.

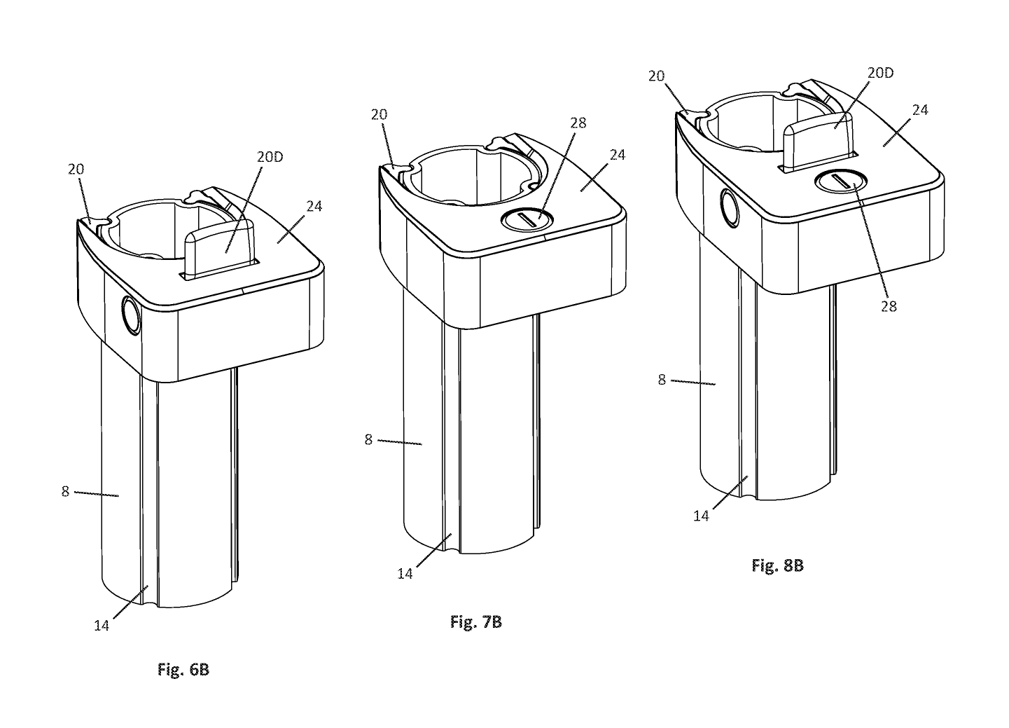

FIGS. 8A and 8B shown an example wherein the carrier 24 is attached to the clamp 20 by sliding. For clarity the connector 26 has been omitted from these Figures. In FIG. 6A part of the carrier 24 is broken away to show the internal functioning. The attachment 20D of the clamp is designed as a resilient lip. The carrier 24 includes a retainer 24A. It will be appreciated that it is also possible that the carrier includes a resilient lip and the clamp includes a retainer In this example the carrier 24 includes a lock 28. The lock 28 can be a key operated lock. Alternatively the lock 28 can be a numerical lock. When the lock 28 is brought from the unlocked to the locked situation, a latch of the lock is brought from a releasing position into a locking position in which it engages the resilient lip. With the latch in the locking position the lip cannot be moved to release the rod and the carrier is locked onto the clamp.

It will be appreciated that many different types of accessories are conceivable. Hence, many different designs of accessories can be made. According to an aspect of the invention, one or more designers, e.g. a community of designers, can design accessories according to the invention described herein. Possibly the designers can submit their respective designs to one or more design authorities. It will be appreciated that instead of an accessory, the designer may also design an accessory assembly including an accessory and a clamp, and optionally a carrier.

The design authority can evaluate the designs. Some designs can be approved for manufacture by the design authority. A design that has been approved can be manufactured. Thereto the approved design can be provided to a manufacturer. The manufacturer can manufacture the accessory according to the approved design. Optionally, the manufacturer can add a clamp according to the invention to the manufactured accessory according to the design. Optionally, the manufacturer can add a carrier according to the invention to the manufactured accessory according to the design. The manufacturer can manufacture an accessory assembly including the accessory according to the approved design and a clamp, and optionally a carrier. It is possible that the manufacturer manufactures the approved accessory with the clamp and/or the carrier integrated to it. The manufacturer can manufacture the accessory assembly according to the approved designed of the accessory assembly. The manufactured accessory or accessory assembly can be provided for use. The accessory assembly can e.g. be provided for sale.

It will be appreciated that the designer may be independent from the manufacturer and the design authority. It is also possible that the designer is related to the manufacturer. The designer may e.g. be a in-house designer of the manufacturer. It is also possible that the manufacturer is related to the design authority. The manufacturer may e.g. be a manufacturing facility of the design authority.

More in general is provided a method for providing an accessory or an accessory assembly, the method including receiving a design of an accessory or an accessory assembly, having an accessory or accessory assembly manufactured according to the design, and providing the manufactured accessory or accessory assembly. The method can include evaluating the design and determining whether or not the design will be approved for manufacture.

In an example, the designs can be submitted to the design authority via a communications network, e.g. via a message such as an email message, via a dropbox, and/or via a web portal. In an example, the design authority provides a website to which the designs can be uploaded. In an example, the design authority provides a design tool, such as a computer aided design program for allowing the designers to design the accessories and/or the accessory assemblies. In an example, the design tool is an online design tool, accessible via the internet. The design tool can include building blocks, such as one or more building blocks representing clamps, and/or one or more building blocks representing carriers.

In an example, the manufacturer includes a plurality of manufacturers. Different accessories or accessory assemblies may be manufactured by different manufacturers. Different parts of accessories or accessory assemblies may be manufactured by different manufacturers.

In an example, the manufactured accessories and/or accessory assemblies are offered via a webshop. The manufactured accessory and/or accessory assembly may be shown in the webshop, e.g. as a photograph or video. It is also possible that a computer rendering of the approved design is shown in the webshop. It is possible that the approved designs are offered in the webshop, and that manufacture of the accessory and/or accessory assembly according to the approved design is only started upon selection, such as purchase, of the accessory and/or accessory assembly in the webshop by a consumer. It will be appreciated that it is possible that the accessory and/or accessory assembly according to the approved design is only manufactured after a predetermined number that accessory and/or accessory assembly have been selected, e.g. as a pre-order or pledge, by consumers.

It is possible that the designer of the accessory or accessory assembly is indicated in the webshop. It is possible that the designer of the accessory or accessory assembly receives a compensation for sale of an accessory or accessory assembly according to his/her design.

Although in this example a webshop is mentioned, other points of sale are possible, such as shops, shop-in-shops, marketplaces or the like. Although in this example is referred to sale of the accessory or accessory assembly, other methods of providing the manufactured accessory or accessory assembly for use can be contemplated, such as renting, leasing, loaning, donating, etc. Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the example of FIG. 1 the bicycle is designed as an electric bicycle. It will be clear that the bicycle can also be a fully muscle force propelled bicycle. The bicycle can be a foldable bicycle. The bicycle can be a mountain bike. The bicycle can be a racing bike.

In the example of FIGS. 3A-3D the beam has grooves and the clamp has corresponding ridges. It will be appreciated that it is also possible that the beam has ridges and the clamp has corresponding grooves. It is also possible that the beam has grooves and ridges and the clamp has corresponding ridges and grooves.

In the examples the carrier is slid onto the clamp in a direction parallel to a longitudinal direction of the beam. It is also possible that the carrier is slid onto the clamp in a direction substantially radial to the beam. It is also possible that the carrier is rotatingly slid, e.g. twisted, onto the clamp. It is also possible that the carrier is clicked and/or clamped onto the clamp.

In the examples the beams have a generally round or oval cross section. It will be appreciated that other cross sections are possible that allow the clamp to be prevented from rotation around the beam, such as polygonal, e.g. triangular, square, rectangular, etc.

It will be appreciated that the number of grooves and/or ridges of the beam can be one, two, three, four, five, six, seven, eight, nine, ten or any desired number. It will be clear that not all grooves need to have the same cross sectional shape and/or dimensions. It will be clear that not all ridges need to have the same cross sectional shape and/or dimensions.

In the examples the clips are hingedly connected to the base of the clamp. It will be appreciated that the hinging can also be effected by means of flexibility of the clamp.

In examples the attachment of the clamp is designed as a resilient lip cooperating with a retainer of the carrier for locking the carrier onto the clamp. It is also possible that carrier includes a resilient lip cooperating with a retainer of the clamp for locking the carrier onto the clamp. It is also possible to lock the carrier onto the clamp by means of magnets, screw connection, a pen and hole connection, a spring, a combination thereof, etc.

In any embodiment, the clamp may include a friction material, e.g. rubber, silicone or the like, on a side facing the beam when clamped. The friction material may further aid in preventing rotation of the clamp relative to the beam.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. Bicycle system including a bicycle and an accessory,
the bicycle including:
a frame including at least one beam,
the at least one beam having a substantially constant cross section along its length;
the accessory being mounted to the frame by:
a clamp arranged to be clamped to the at least one beam;
wherein the at least one beam and/or the clamp has a cross section arranged for preventing rotation of the clamp around an axial direction of the at least one beam.

2. (canceled)

3. The bicycle system according to claim 1, wherein the at least one beam has at least one groove and/or ridge along the length of an external surface and the clamp has at least one ridge and/or groove complementary to the at least one groove and/or ridge of the at least one beam.

4.-5. (canceled)

6. The bicycle system according to claim 1, wherein the clamp includes a base and two clips hingedly or flexibly connected to the base, each clip including a ridge arranged for cooperating with a respective groove of the at least one beam.

7. (canceled)

8. The bicycle system according to claim 1, including a carrier, the carrier being positioned onto the clamp so as to prevent unclamping of the clamp from the at least one beam.

9.-10. (canceled)

11. The bicycle system according to claim 8, wherein the carrier is arranged to be slid over the clamp so as to partly surround the clamp so as to prevent unclamping of the clamp from the at least one beam.

12. (canceled)

13. The bicycle system according to claim 8, wherein the clamp includes a resilient lip and the carrier includes a retainer arranged to hook behind the resilient lip and/or wherein the carrier includes a resilient lip and the clamp includes a retainer arranged to hook behind the resilient lip.

14. The bicycle system according to claim 8, wherein the clamp and the carrier include cooperating means arranged to lock the carrier onto the clamp.

15.-21. (canceled)

22. The bicycle system according to claim 1, wherein the at least one beam includes at least two of: a chain stay, a seat stay, a seat tube, a head tube, a top tube, a rear tube, a down tube, a fork, a stem riser, a handlebar, a seat post, a pedal, a stand, a luggage carrier, a hub, sand rims.

23. The bicycle system according to claim 1, wherein the bicycle is an electric bicycle.

24. Accessory assembly including a clamp arranged to be clamped to at least one beam of a frame of a bicycle, the at least one beam having a substantially constant cross section along its length, wherein the clamp is arranged to be clamped to the at least one beam wherein the clamp has a cross section arranged for preventing rotation of the clamp around an axial direction of the at least one beam.

25.-26. (canceled)

27. The accessory assembly according to claim 24, wherein the clamp includes a base and two clips hingedly or flexibly connected to the base, each clip including a ridge arranged for cooperating with a respective groove of the at least one beam.

28. The accessory assembly according to claim 27, wherein the ridges of the clips are dimensioned so as to provide a biasing force onto the grooves of the beam.

29. The accessory assembly according to claim 24, including a carrier, the carrier being positioned onto the clamp so as to prevent unclamping of the clamp from the at least one beam.

30.-36. (canceled)

37. The accessory assembly according to claim 24, including an accessory attachable to the clamp and/or to a carrier.

38. The accessory assembly according to claim 29, wherein the carrier is integral with the accessory, the clamp is integral with the accessory, and/or the carrier is integral with the clamp.

39. The accessory assembly according to claim 24, including an accessory being at least one of: a basket, a light, a bottle holder, a phone holder, a map holder, a fender, a tablet holder, a bag holder, and an ornament.

40. Clamp arranged to be clamped to at least one beam of a frame of a bicycle, the at least one beam having a substantially constant cross section along its length, wherein the clamp is arranged to be clamped to the at least one beam wherein the clamp has a cross section arranged for preventing rotation of the clamp around an axial direction of the at least one beam.

41.-42. (cancelled)

43. The clamp according to claim 40, wherein the clamp includes a base and two clips hingedly or flexibly connected to the base, each clip including a ridge arranged for cooperating with a respective groove of the at least one beam.

44. (canceled)

45. The clamp according to claim 40, including a carrier, the carrier being positioned onto the clamp as to prevent unclamping of the clamp from the at least one beam.

46.-52. (canceled)

53. The clamp according to claim 40, including a connector for connecting an accessory thereto.

54. (canceled)

55. Carrier arranged to be being positioned onto a clamp arranged to be clamped to at least one beam of a frame of a bicycle, the at least one beam having a substantially constant cross section along its length, the clamp being arranged to be clamped to the at least one beam free from rotation around an axial direction of the at least one beam, wherein the carrier is arranged to cooperate with the clamp so as to prevent unclamping of the clamp from the at least one beam.

56. The carrier according to claim 55, wherein the carrier is arranged to at least partly surround the clamp so as to prevent unclamping of the clamp from the at least one beam.

57. The carrier according to claim 56, wherein the carrier has an internal cavity having a shape complementary to an outer shape of the clamp.

58.-59. (canceled)

60. The carrier according to claim 59, wherein the carrier is arranged to be slid onto the clamp in a direction substantially parallel to the longitudinal direction of the at least one beam and/or in a direction substantially radial to the at least one beam.

61.-63. (canceled)

64. The carrier according to claim 55, including a connector for connecting an accessory thereto.

65. The carrier according to claim 55, wherein the carrier is integral with an accessory.

66.-71. (canceled)

72. Method for providing an accessory of an accessory assembly according to claim 24, the method including:
receiving a design of the accessory via a message through a communications network,
having the accessory manufactured according to the design, and
providing the accessory.

73.-76. (canceled)
